(19) United States
(12) Patent Application Publication
(10) Pub. No.: US 2023/0223034 A1
(43) Pub. Date: Jul. 13, 2023

(54) USER INTERFACE FOR DATA TRAJECTORY VISUALIZATION OF SOUND SUPPRESSION APPLICATIONS

(71) Applicant: SKYWORKS SOLUTIONS, INC., Irvine, CA (US)

(72) Inventor: Alexander KAIN, Portland, OR (US)

(21) Appl. No.: 18/093,122

(22) Filed: Jan. 4, 2023

Related U.S. Application Data
(60) Provisional application No. 63/296,456, filed on Jan. 4, 2022.

(51) Int. Cl. G10L 21/0272; H04R 29/00; G10L 21/0208

(52) U.S. Cl. CPC G10L 21/0272; H04R 29/008; G10L 21/0208; G10L 2021/02087

(57) ABSTRACT

In some embodiments, an audio system can be monitored by determining a sound suppression mode, and sampling information representative of an input signal and an output signal resulting from processing of the input signal in the sound suppression mode. The monitoring method can further include providing a display representative of the sampled information.

### CROSS-REFERENCE TO RELATED APPLICATION(S)

This application claims priority to U.S. Provisional Application No. 63/296,456 filed Jan. 4, 2022, entitled USER INTERFACE FOR DATA TRAJECTORY VISUALIZATION OF SOUND SUPPRESSION APPLICATIONS, the disclosure of which is hereby expressly incorporated by reference herein in its respective entirety.

### BACKGROUND

### Field

The present disclosure relates to user interface and techniques for sound suppression applications.

### Description of the Related Art

In some applications, an audio device can be configured to suppress noise in an audio output being provided to a user. Such suppression of noise can be achieved during processing of a signal that results in the audio output.

### SUMMARY

In accordance with some implementations, the present disclosure relates to a method for monitoring an audio system. The method includes determining a sound suppression mode, sampling information representative of an input signal and an output signal resulting from processing of the input signal in the sound suppression mode, and providing a display representative of the sampled information.

In some embodiments, the sound suppression mode can include a mode resulting from a mixture value having a value in a range from a first value for a first state to a second value for a second state, with the first state corresponding to a desired sound having substantially all of a first content and substantially nil amount of a second content, the second state corresponding to a desired sound having substantially nil amount of the first content and substantially all of the second content, the mixture value being a selected one among multiple values in the range, and the multiple values including an unprocessed mixture value for an unprocessed state corresponding to a desired sound having unprocessed first and second contents.

In some embodiments, the mode resulting from the mixture value can further include generating a control output signal based on the selected mixture value, and processing the input signal based on the control output signal to generate the output signal representative of a sound having the first content and/or the second content according to the selected mixture value.

In some embodiments, the first content can include an ambient noise content, and the second content can include a speech content.

In some embodiments, the range can be selected such that the first value is −Mₗᵢₘᵢₜ and the second value is +Mₗᵢₘᵢₜ. The control output signal can be represented as Output=(Mₗᵢₘᵢₜ−abs(mix))*unprocessed+abs(mix)*processed, where processed =f(unprocessed) with f representing a sound suppression function and mix representing the selected mixture value. The sound suppression function can include an artificial intelligence sound suppression function. The quantity Mₗᵢₘᵢₜ can have a value of 1, such that the control output signal is represented as Output=(1−abs(mix))*unprocessed+abs(mix)*processed, where processed=f(unprocessed).

In some embodiments, the range can be selected such that the unprocessed mixture value is approximately at middle of the range.

In some embodiments, the obtaining of the mixture value can include obtaining an input through a device that generates the sound. The sound-generating device can be, for example, a headphone.

In some embodiments, the obtaining of the mixture value can include obtaining an input through a portable device in communication with a device that generates the sound. The communication between the portable device and the sound-generating device can include a wireless communication. The portable device can be, for example, a smartphone and the sound-generating device can be, for example, a headphone.

In some embodiments, the obtaining of the input through the portable device can include providing a graphic user interface that allows the user to select the mixture value.

In some embodiments, the multiple values in the range can be discrete values. In some embodiments, the multiple values in the range can be parts of continuous or approximately continuous values in the range.

In some embodiments, some or all of the determining of the sound suppression mode, sampling of the information, and providing of the display can be performed by a portable device such as a smartphone. In some embodiments, the portable device can include an application having a graphic user interface that provides the display.

In some implementations, the present disclosure relates to a system that includes an audio device including a speaker for providing an output sound to a user, and an audio processor configured to generate the output sound based on an audio signal. The system further includes a portable device configured to communicate with the audio device. The portable device includes an application that allows the user to monitor the operation of the audio processor. The portable device further includes a monitor component configured to determine a sound suppression mode being implemented in the audio processor. The monitor component is further configured to sample information representative of an input signal and an output signal resulting from processing of the input signal in the sound suppression mode, and to provide a display representative of the sampled information.

In some embodiments, the portable device can be a smartphone and the audio device can be a headphone. In some embodiments, the application on the portable device can include a graphic user interface having the display.

In some embodiments, the sound suppression mode can include a mode resulting from a mixture value having a value in a range from a first value for a first state to a second value for a second state, with the first state corresponding to a desired sound having substantially all of a first content and substantially nil amount of a second content, the second state corresponding to a desired sound having substantially nil amount of the first content and substantially all of the second content, the mixture value being a selected one among multiple values in the range, and the multiple values including an unprocessed mixture value for an unprocessed state corresponding to a desired sound having unprocessed first and second contents.

In some embodiments, the mode resulting from the mixture value can further include generating a control output signal based on the selected mixture value, and processing the input signal based on the control output signal to generate the output signal representative of a sound having the first content and/or the second content according to the selected mixture value.

In some embodiments, the first content can include an ambient noise content, and the second content can include a speech content.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a block diagram of an audio device having a control component, an audio processor component and a speaker component.

FIG. 2 depicts an example system that includes an audio device and a portable device.

FIG. 3 shows an example display that can be implemented as a monitor component of FIG. 2.

FIG. 4 shows a process that can be implemented to provide a monitoring functionality described in reference to FIGS. 1 to 3.

FIG. 5 shows that in some embodiments, the control component of FIG. 1 can be configured to provide a user input functionality.

FIG. 6 depicts an example system that includes an audio device and a portable device with a user interface for providing control functionality for the audio device.

FIG. 7 shows that in some embodiments, a system can include an audio device and a portable device having user interfaces for providing control functionality for the audio device and for providing monitoring functionality as described herein.

FIG. 8 shows that in some embodiments, a system can include an audio device and a portable device having a user interface that provides control functionality for the audio device and monitoring functionality as described herein.

FIG. 9 shows a process that can be implemented to provide control functionality described in reference to FIGS. 5 to 8.

FIG. 10 shows that in some embodiments, a semiconductor die having a substrate can include a circuit configured to one or more functionalities as described herein.

FIG. 11 shows that in some embodiments, a module having a packaging substrate can include a circuit configured to one or more functionalities as described herein.

FIG. 12 shows that in some embodiments, an audio device and/or a portable device can include an interface functionality having one or more features as described herein.

FIG. 13 depicts a system where one or more features of the present disclosure can be implemented.

FIG. 14 shows a system that can be a more specific example of the system of FIG. 13.

FIG. 15 shows an example of an audio amplifier circuit that can provide one or more control functionalities as described herein.

### DETAILED DESCRIPTION OF SOME EMBODIMENTS

The headings provided herein, if any, are for convenience only and do not necessarily affect the scope or meaning of the claimed invention.

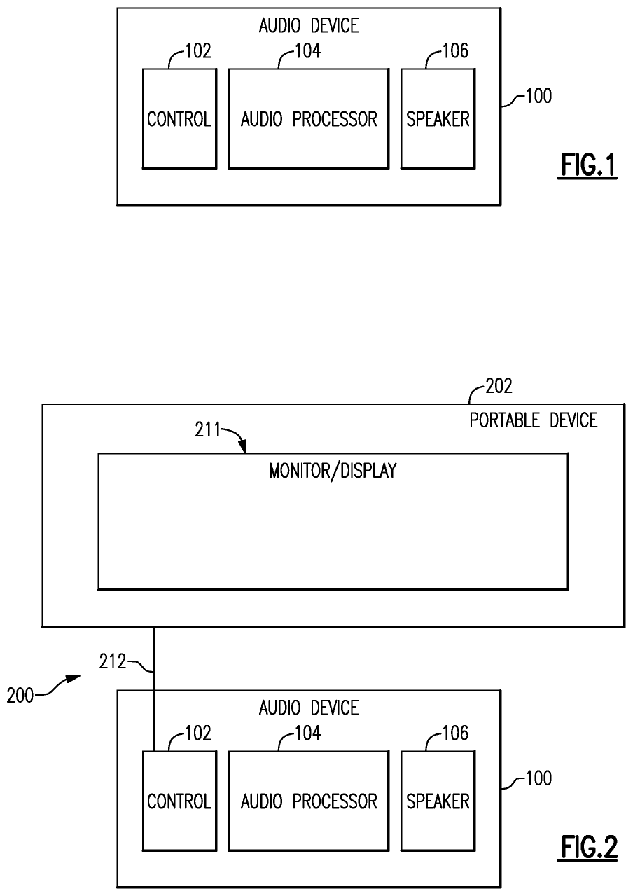

FIG. 1 depicts a block diagram of an audio device 100 having a control component 102, an audio processor component 104 and a speaker component 106. In some embodiments, the audio processor component 104 can be configured to convert an electrical signal (e.g., analog, digital or some combination thereof) into an audio signal that drives the speaker 106. In some embodiments, the control component 102 can be configured to control the operation of the audio processor component 104. In some embodiments, such control functionality can include, or be associated with, selective filtering of first and second groups of sound content, such as speech and ambient noise.

In some embodiments, the audio device 100 of FIG. 1 can be, for example, a headphone. Such a headphone having one or more features as described herein can be a stand-alone device, a part of a system with a separate portable device, or some combination thereof. If implemented in a system with a separate portable device, the audio device 100 can be in communication with the separate portable device (e.g., a smartphone) through one or more wires, wirelessly, or some combination thereof.

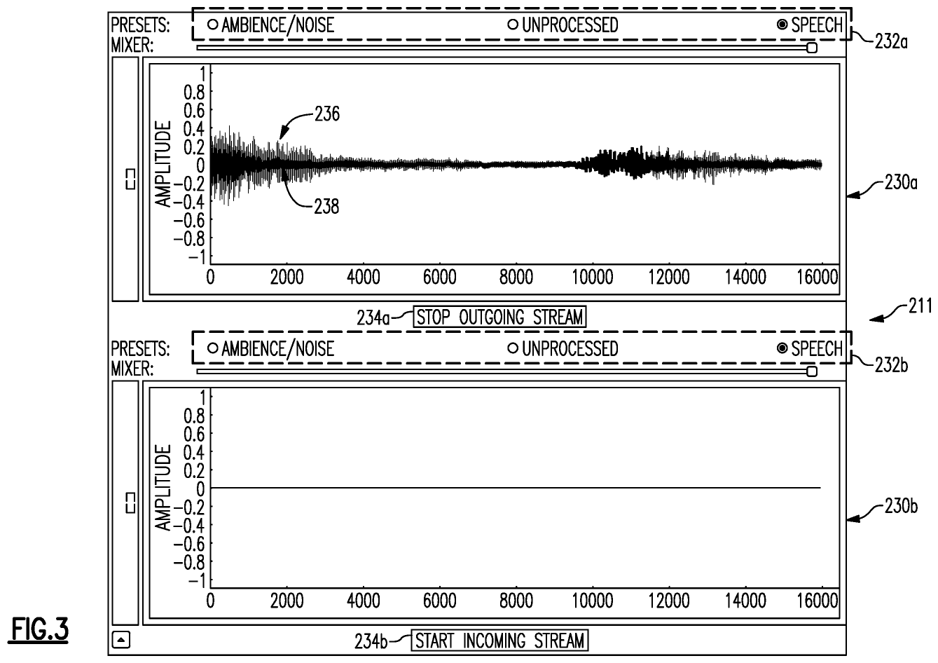

FIG. 2 depicts an example system 200 that includes an audio device 100 and a portable device 202. In some embodiments, the audio device 100 and the portable device 202 can be configured to support a communication link 212 therebetween. Such a communication link can be one way (e.g., from the portable device 202 to the audio device 100), or both ways therebetween.

In some embodiments, the communication link 212 can be achieved through one or more wires, wirelessly, or some combination thereof. Such a communication link can be utilized to provide a transfer of a user input. In some embodiments, such a user input can be based on a monitor component 211 that provides information to a user. In some embodiments, such a monitor component can include a display for providing the information to the user. Examples related to the foregoing control functionality can be implemented based on the monitor component are described herein in greater detail.

FIG. 3 shows an example display 211 that can be implemented as the monitor component 211 of FIG. 2. In the example of FIG. 3, a display panel 230a at the upper portion of the display 211 is shown to display information 236 representative of an input to an audio processor and information 238 representative of an output of the audio processor. Such an output can result from selective filtering of first and second groups of sound content such as speech and ambient noise. Additional details related to such selective filtering are provided herein.

Referring to FIG. 3, the display 211 is shown to include a mode indicator 232a. For example, speech filtering mode is shown to be set; thus, the input information 236 is representative of an input that includes speech content along with ambient noise content, and the output information 238 is representative of an output that includes the ambient noise content with some or all of the speech content being removed.

In the example of FIG. 3, the input and output information 236, 238 are implemented as waveforms. Based on such visual representations of the input and output, the amount of sound content suppression can be inferred. Based on such suppression information, a user utilizing the selective sound suppression can either confirm a desired setting or adjust the amount of processing. In some embodiments, such an amount of processing can be based on a sliding scale between a first state with ambient noise and no speech content to a second state with speech and no ambient noise content. Examples related to such a sliding scale control of sound processing are provided herein.

In some embodiments, the input and output information 236, 238 of the display 211 can be implemented as, for example, waveforms, derived statistics (e.g., RMS energy over 200 ms sampled every 100 ms), or some combination thereof. Such information can be monitored real-time, approximately real-time, for a selected time duration (e.g., for 1 second), or some combination thereof.

In the example of FIG. 3, a second display panel indicated as 230b is shown to be provided for providing information (e.g., input signal trace). Such a display panel can include or be associated with a mode indicator, such as the mode indicator 232a.

In some embodiments, the two example display panels 230a, 230b can be configured to operate together in synchronous manner (e.g., for the same time interval), operate independently (e.g., the first display panel monitoring a first time interval and the second display panel monitoring a second time interval that may or may not be the same as the first time interval), or some combination thereof. In some embodiments, each of such display panels can include an activation button.

For example, in FIG. 3, a control button 234a has been touched to start a monitoring stream. To stop such a monitoring stream, the same control button can be touched.

In another example, in FIG. 3, the lower display panel 230b is shown to be inactive. To activate a monitoring stream of the lower display panel 230b, a control button 234b can be touched.

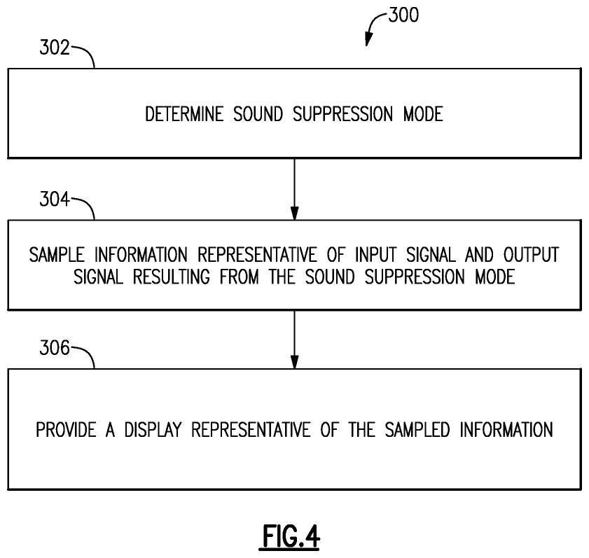

FIG. 4 shows a process 300 that can be implemented to provide a monitoring functionality described in reference to FIGS. 1 to 3. In a process block 302, a sound suppression mode can be determined. In a process block 304, information representative of input signal and output signal resulting from the sound suppression mode can be sampled. In a process block 306, a display representative of the sampled information can be provided for a user. Based on such display, the user can either verify a desired setting or change the setting to provide a different mixture of ambient noise and speech contents.

It is noted that traditionally, the amount or the nature of a sound content being suppressed by a sound suppression application is not known. In some applications, a simple momentary input-level energy gauge is provided, but while such an application shows how much energy is in the input, it is not clear from such information how much energy of the total energy is ambient noise vs speech. Moreover, such a gauge typically only provides measurement at a single sampling time.

As described herein, one or more features of the present disclosure can be implemented to provide more intuitive information for a user. For example, a monitoring component as described herein can measures characteristics over time, as opposed to just a momentary measurement. In another example, the monitoring component can display both input and output, and thus the amount of suppression can easily be inferred by the user. Yet in another example, visualization of the monitored information can be provided by one or more displays, and such display(s) can be configured to show, for example, waveforms, processed information based on the waveforms (e.g., calculated difference between input and output RMS energy trajectories), or some combination thereof.

FIG. 5 shows that in some embodiments, the control component of FIG. 1 can be configured to provide a user input functionality. For example, a selection knob 112 can be provided to allow a user to select a mixture value within a range between a first state having ambient noise but no speech and a second state having speech but no ambient noise. In between such states, an unprocessed state can include both speech and ambient noise.

In the example of FIG. 5, the selection knob 112 can be implemented as, for example, a hardware knob, a graphic user interface knob responsive to touch, or some combination thereof. In some embodiments, the control component 102 can be implemented on the audio device itself, on a separate portable device, or some combination thereof.

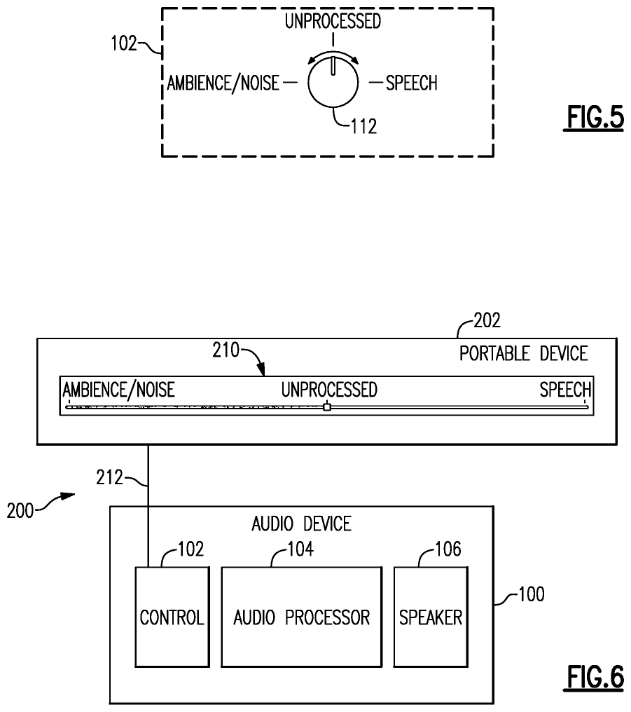

FIG. 6 depicts an example system 200 that includes an audio device 100 and a portable device 202. In some embodiments, the audio device 100 and the portable device 202 can be configured to support a communication link 212 therebetween. Such a communication link can be one way (e.g., from the portable device 202 to the audio device 100), or both ways therebetween.

In some embodiments, the communication link 212 can be achieved through one or more wires, wirelessly, or some combination thereof. Such a communication link can be utilized to provide a transfer of a user input provided through a graphic user interface 210 of the portable device 202. Such a user input can include a selected mixture value similar to the example of FIG. 5 (e.g., a mixture value within a range between a first state having ambient noise but no speech and a second state having speech but no ambient noise, with an unprocessed state therebetween and including both speech and ambient noise.

In the example of FIG. 6, a control component 102 can be implemented to receive a signal associated with the foregoing user input and generate one or more control signals to operate an audio processor 104 in accordance with the selected mixture value. Based on such operation of the audio processor 104, sound provided to a user through a speaker 106 can be in one of a number of states between the first and second states.

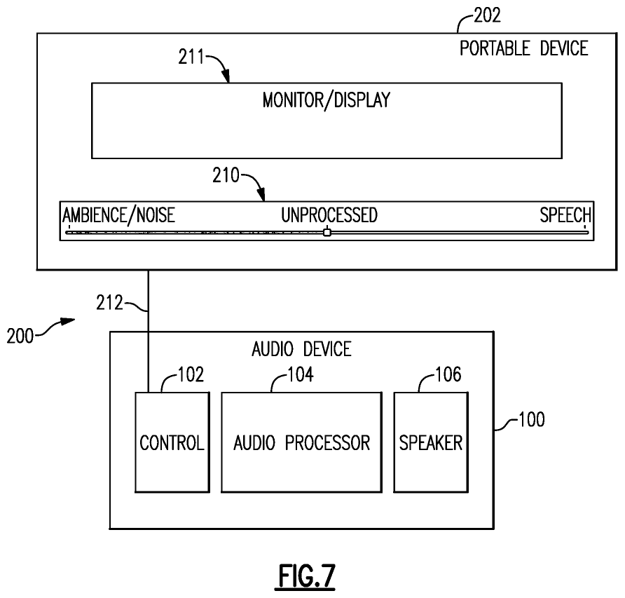

FIG. 7 shows that in some embodiments, a system 200 can include an audio device 100 and a portable device 202 having user interfaces for providing control functionality (210) for the audio device 100 and for providing monitoring functionality (211) as described herein. In such an example, the control functionality portion 210 in FIG. 7 can be provided in a manner similar to the control functionality described herein in reference to FIGS. 5, 6 and 9; and the monitoring functionality portion 211 of FIG. 7 can be provided in a manner similar to the monitoring functionality described herein in reference to FIGS. 2 to 4.

FIG. 8 shows that in some embodiments, a system 200 can include an audio device 100 and a portable device 202 having a common user interface 211 configured to provide control functionality (210) for the audio device 100 and for providing monitoring functionality (213) as described herein. In such an example, the control functionality portion 210 in FIG. 8 can be provided in a manner similar to the control functionality described herein in reference to FIGS. 5, 6 and 9; and the monitoring functionality portion of FIG. 8 can be provided in a manner similar to the monitoring functionality described herein in reference to FIGS. 2 to 4.

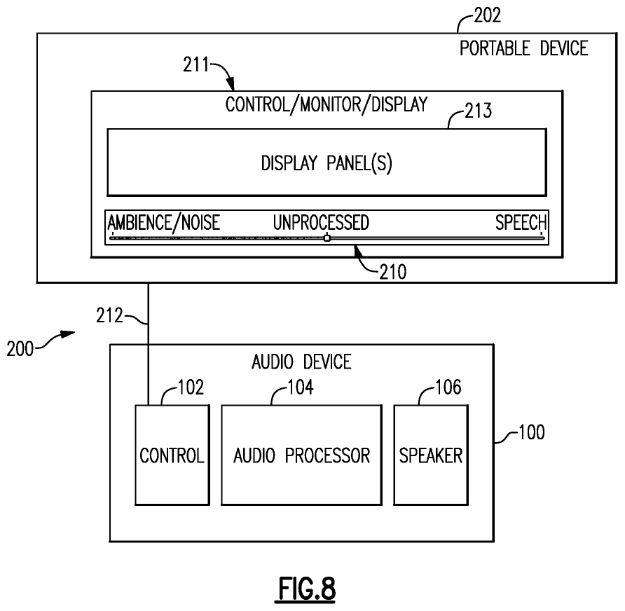

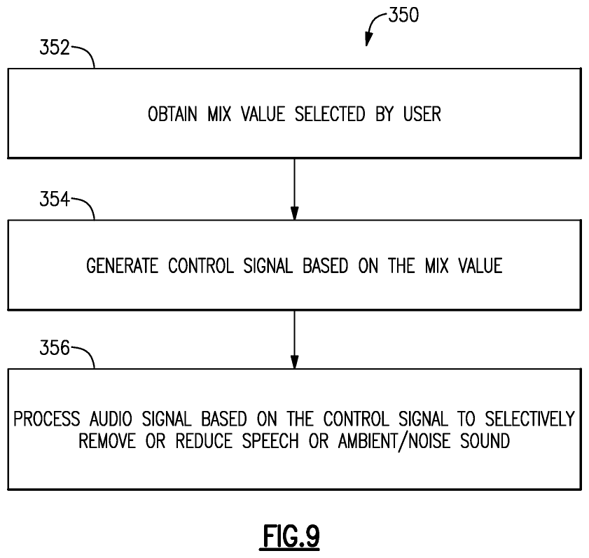

FIG. 9 shows a process 350 that can be implemented to provide a control functionality described in reference to FIGS. 5 to 8. In a process block 352, a mix value selected by a user can be obtained. In a process block 354, a control signal can be generated based on the selected mix value. In a process block 356, an audio signal can be processed based on the control signal to selectively remove or reduce speech or ambient noise sound.

It is noted that in many noise suppression applications, noise suppression is achieved by either providing a binary switch for turning noise suppression on or off, or providing a functionality that controls the amount of noise reduction. For the latter implementation, an output of noise reduction control can be represented as

Output=(1−mix)*unprocessed+mix*processed, (1)

where processed=f(unprocessed) with f representing a noise suppression function (e.g., an artificial intelligence (Al) noise suppression function), and mix representing a mixture quantity. For mix=0, one can see that Equation 1 becomes output=unprocessed content that includes speech and noise. For mix=1, one can see that Equation 1 becomes output=processed content having just the speech.

Based on the foregoing example, one can see that the unprocessed content has both noise and speech, and the process content only has speech. Thus, it is possible to create an “ambient” or “noise” content with speech being removed, by subtracting the processed content from the unprocessed content. In some applications, such a functionality can be useful or desirable if a user wants to block out nearby human speech and listen to environmental sound (e.g., waterfall, birds chirping, etc.).

As described herein, circuits, devices, systems, user interfaces and/or methods can be implemented to provide a user with an option for selectively removing speech in an output being provided to the user through an audio device.

Although such examples are described in the context of speech being removed and ambient noise being retained in a selective manner, it will be understood that one or more features of the present disclosure can also be implemented in more generalized manners. For example, if sound content being provided to a user can be grouped into first and second groups, then removal and retaining of such groups of sound content can be achieved in a selected manner as described herein.

It is noted that in the foregoing example involving speech and ambient noise, the speech can be considered to be in a first group of sound content, and the ambient noise can be considered to be in a second group of sound content. Alternatively, the ambient noise can be considered to be in a first group of sound content, the speech can be considered to be in a second group of sound content.

In some embodiments, the range between the first and second states in each of the examples of FIGS. 5 and 6 can be configured to provide a mixture value (mix) in an interval [−Mₗᵢₘᵢₜ, +Mₗᵢₘᵢₜ], with the unprocessed state corresponding to a mixture value of zero (0). Thus, the first state having ambient noise but no speech corresponds to a mixture value of or mix −Mₗᵢₘᵢₜ, and the second state having speech but no ambient noise corresponds to a mixture value of +Mₗᵢₘᵢₜ, or mix=+Mₗᵢₘᵢₜ. In between such states, a mixture value between −Mₗᵢₘᵢₜ and +Mₗᵢₘᵢₜ can correspond to a respective combination of ambient noise and speech.

In some embodiments, the foregoing mixture value (mix) can have a plurality of values between the first state (ambient noise only) and the unprocessed state, and a plurality of values between the unprocessed state and the second state (speech only). In some embodiments, the number of mixture values between the first state and the unprocessed state may or may not be the same as the number of mixture values between the unprocessed state and the second state.

In some embodiments, the foregoing mixture value (mix) can have a continuous or substantially continuous value between the first state (ambient noise only) and the second state (speech only).

In some embodiments, an output of sound selection control (e.g., by the control component 102 in FIG. 1) can be represented as

Output=Mₗᵢₘᵢₜ−abs(mix))*unprocessed+abs(mix)*processed (2)

where processed=f(unprocessed) with f representing a sound suppression function (e.g., an artificial intelligence (Al) sound suppression function), and mix representing a selected mixture value in an interval [−Mₗᵢₘᵢₜ, +Mₗᵢₘᵢₜ]. For mix=0, one can see that Equation 2 becomes output=+Mₗᵢₘᵢₜ*unprocessed that includes speech and noise.

In a more specific example, Mₗᵢₘᵢₜ it can have a value of 1, such that a selected mixture value is in an interval [−1, +1], and Equation 2 becomes

Output=(1−abs(mix))*unprocessed+abs(mix)*processed (3)

In the context of the example of Equation 3, it is noted that the selected mixture value (mix) of −1 corresponds to a first state with ambient noise only, and the output of Equation 3 becomes Output=processed=f(unprocessed); the selected mixture value (mix) of 0 corresponds to an unprocessed state with ambient noise and speech, and the output of Equation 3 becomes Output=unprocessed; and the selected mixture value (mix) of +1 corresponds to a second state with speech only, and the output of Equation 3 becomes Output=processed=f(unprocessed).

It is also noted that when the mixture value is in a range 0≤mix 1, the output of Equation 3 can be calculated with processed =f(unprocessed), with the mix=1 being a special case discussed above. When the mixture value is in a range −1≤mix <0, the output of Equation 3 can be calculated with processed=unprocessed−f(unprocessed), with the mix=−1 being a special case discussed above.

FIGS. 10 to 12 show examples of various products where one or more features of the present disclosure can be implemented. For example, FIG. 10 shows that in some embodiments, a semiconductor die 400 having a substrate 402 can include a monitor circuit 211 having one or more features as described herein. In some embodiments, the die 400 can also include a circuit for controlling a display that provides information associated with the monitor circuit 211. In some embodiments, the monitor circuit 211 may or may not include a control functionality described herein (e.g., in reference to FIGS. 5 to 9).

In another example, FIG. 11 shows that in some embodiments, a module 500 having a packaging substrate 502 can include a monitor circuit having one or more features as described herein. Such a monitor circuit can be implemented on a die 400, similar to the die 400 of FIG. 10, and the die 400 can be mounted on the packaging substrate 502. In some embodiments, the monitor circuit 211 may or may not include a control functionality described herein (e.g., in reference to FIGS. 5 to 9).

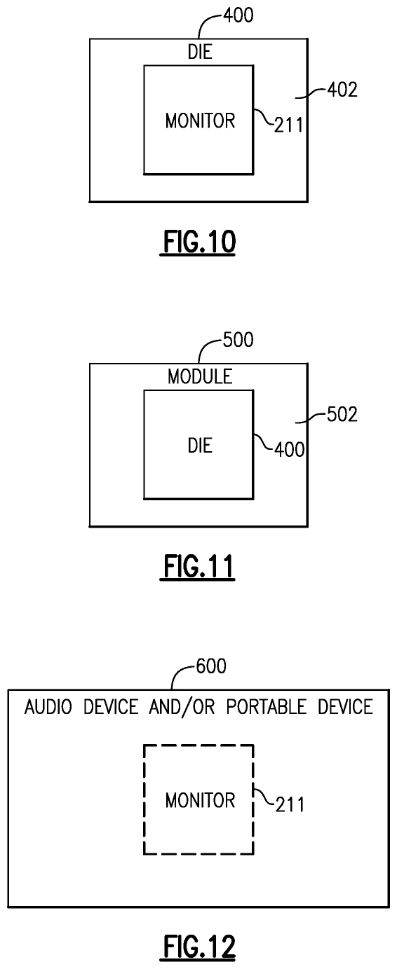

In yet another example, FIG. 12 shows that in some embodiments, a portable device (e.g., a wireless device such as a smartphone) can include a monitor functionality block 211 having one or more features as described herein. In some embodiments, the monitor functionality block 211 may or may not include a control functionality described herein (e.g., in reference to FIGS. 5 to 9).

FIG. 13 depicts a system 810 where one or more features of the present disclosure can be implemented. In some embodiments, such a system can include a wearable audio device 802 in communication with a host device 808. Such communication, depicted as 807, can be supported by, for example, a wireless link such as a short-range wireless link in accordance with a common industry standard, a standard specific for the system 810, or some combination thereof. In some embodiments, the wireless link 807 includes digital format of information being transferred from one device to the other (e.g., from the host device 808 to the wearable audio device 802).

In FIG. 13, the wearable device 802 is shown to include an audio amplifier circuit 800 that provides an electrical audio signal to a speaker 804 based on a digital signal received from the host device 808. Such an electrical audio signal can drive the speaker 804 and generate sound representative of a content provided in the digital signal, for a user wearing the wearable device 802.

In some embodiments, one or more features of selective filtering of speech and noise, and/or monitoring of sound suppression functionality such as the foregoing selective filtering of speech and noise, can be implemented to operate independently from the foregoing digital signal received from the host device, or in conjunction with the digital signal received from the host device. In some embodiments, the wearable device 802 can include one or more audio input devices such as microphones to sense sound content present at or about the wearable device to thereby allow selective filtering of such sound content. In some embodiments, at least some of an interface for configuring such selective filtering can be implemented in the host device 808.

In FIG. 13, the wearable device 802 can be a wireless device; and thus typically includes its own power supply 806 including a battery. Such a power supply can be configured to provide electrical power for the audio device 802, including power for operation of the audio amplifier circuit 800.

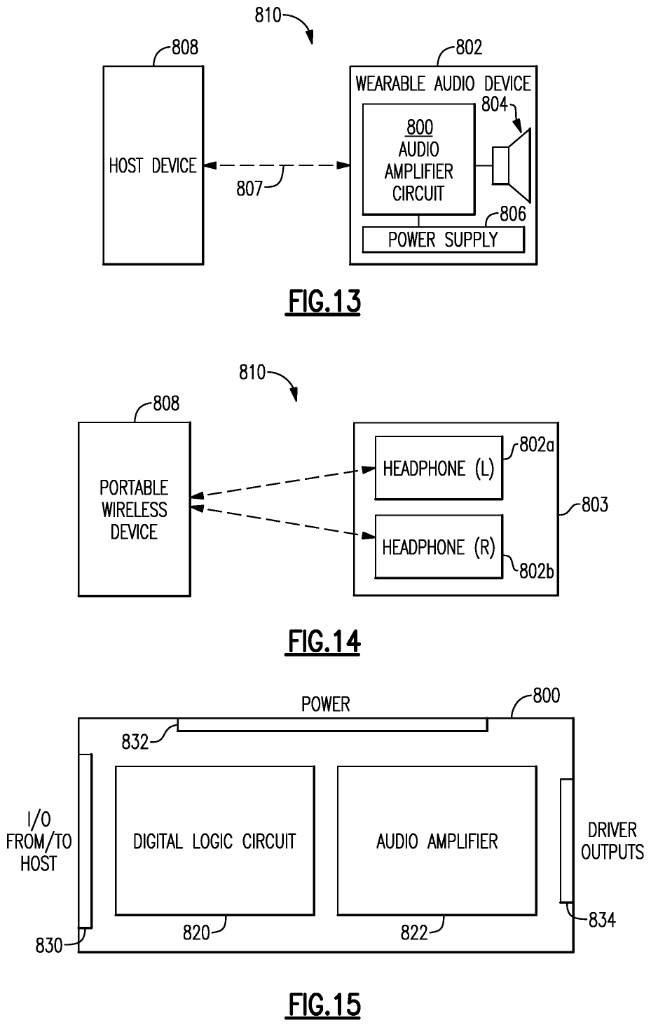

In some embodiments, the host device 808 can be a portable wireless device such as, for example, a smartphone, a tablet, an audio player, etc. It will be understood that such a portable wireless device may or may not include phone functionality such as cellular functionality. In such an example context of a portable wireless device being a host device, FIG. 14 shows a more specific example of the wearable audio device 802 of FIG. 13.

FIG. 14 shows that in some embodiments, the wearable audio device 802 of FIG. 13 can be implemented as part of a headphone 803 configured to be worn on the head of a user, such that the audio device (802a or 802b) is positioned on or over a corresponding ear of the user. In the example of FIG. 14, a pair of audio devices (802a and 802b) can be provided—one for each of the two ears of the user. In some embodiments, each audio device (802a or 802b) can include its own components (e.g., audio amplifier circuit, speaker and power supply) described above in reference to FIG. 13. In some embodiments, one audio device (802a or 802b) can include an audio amplifier circuit that provides outputs for the speakers of both audio devices. In some embodiments, the pair of audio devices 802a, 802b of the headphone 803 can be operated to provide, for example, stereo functionality for left (L) and right (R) ears.

FIG. 15 shows that in some embodiments, the audio amplifier circuit 800 of FIG. 13 can include a number of functional blocks. More particularly, in FIG. 15, an audio amplifier circuit 800 is shown to include a digital logic circuit block 820 and an amplifier block 822. In some embodiments, one or more features associated with selective filtering of speech and noise as described herein can be implemented in the digital logic circuit block 820.

In FIG. 15, the audio amplifier circuit 800 is shown to further include various interfaces to allow the audio amplifier circuit 800 to interact with other devices external to the audio amplifier circuit 800. For example, an interface indicated as 830 can be configured to support input/output (I/O) functionality with respect to a host device (e.g., 808 in FIG. 13). An interface indicated as 834 can be configured to support providing of electrical audio signals to a speaker (e.g., 804 in FIG. 13). An interface indicated as 832 can be configured to support providing of electrical power to various parts of the audio amplifier circuit 800.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for monitoring an audio system, the method comprising:
determining a sound suppression mode;
sampling information representative of an input signal and an output signal resulting from processing of the input signal in the sound suppression mode; and
providing a display representative of the sampled information.

2. The method of claim 1 wherein the sound suppression mode includes a mode resulting from a mixture value having a value in a range from a first value for a first state to a second value for a second state, the first state corresponding to a desired sound having substantially all of a first content and substantially nil amount of a second content, the second state corresponding to a desired sound having substantially nil amount of the first content and substantially all of the second content, the mixture value being a selected one among multiple values in the range, the multiple values including an unprocessed mixture value for an unprocessed state corresponding to a desired sound having unprocessed first and second contents.

3. The method of claim 2 wherein the mode resulting from the mixture value further includes generating a control output signal based on the selected mixture value, and processing the input signal based on the control output signal to generate the output signal representative of a sound having the first content and/or the second content according to the selected mixture value.

4. The method of claim 3 wherein the first content includes an ambient noise content, and the second content includes a speech content.

5. The method of claim 3 wherein the range is selected such that the first value is −Mₗᵢₘᵢₜ and the second value is +Mₗᵢₘᵢₜ.

6. The method of claim 5 wherein the control output signal is represented as Output=(Mₗᵢₘᵢₜ−abs(mix))*unprocessed+abs(mix)* processed, where processed=f(unprocessed) with f representing a sound suppression function and mix representing the selected mixture value.

7. The method of claim 6 wherein the sound suppression function includes an artificial intelligence sound suppression function.

8. The method of claim 6 wherein the quantity Mₗᵢₘᵢₜ has a value of 1, such that the control output signal is represented as Output=(1−abs(mix))* unprocessed+abs(mix)*processed, where processed=f(unprocessed).

9. The method of claim 3 wherein the range is selected such that the unprocessed mixture value is approximately at middle of the range.

10. The method of claim 3 wherein the obtaining of the mixture value includes obtaining an input through a device that generates the sound.

11. The method of claim 10 wherein the sound-generating device is a headphone.

12. The method of claim 3 wherein the obtaining of the mixture value includes obtaining an input through a portable device in communication with a device that generates the sound.

13. The method of claim 12 wherein the communication between the portable device and the sound-generating device includes a wireless communication.

14. The method of claim 12 wherein the portable device is a smartphone and the sound-generating device is a headphone.

15. The method of claim 12 wherein the obtaining of the input through the portable device includes providing a graphic user interface that allows the user to select the mixture value.

16. The method of claim 3 wherein the multiple values in the range are discrete values.

17. The method of claim 3 wherein the multiple values in the range are parts of continuous or approximately continuous values in the range.

18. The method of claim 1 wherein some or all of the determining of the sound suppression mode, sampling of the information, and providing of the display is/are performed by a portable device.

19. (canceled)

20. The method of claim 18 wherein the portable device includes an application having a graphic user interface that provides the display.

21. A system comprising:
an audio device including a speaker for providing an output sound to a user, and an audio processor configured to generate the output sound based on an audio signal; and
a portable device configured to communicate with the audio device, the portable device including an application that allows the user to monitor the operation of the audio processor, the portable device including a monitor component configured to determine a sound suppression mode being implemented in the audio processor, the monitor component further configured to sample information representative of an input signal and an output signal resulting from processing of the input signal in the sound suppression mode, the monitor component further configured to provide a display representative of the sampled information.

22. (canceled)

23. (canceled)

24. (canceled)

25. (canceled)

26. (canceled)
